(19) United States
(12) Patent Application Publication
(10) Pub. No.: US 2013/0194322 A1
(43) Pub. Date: Aug. 1, 2013

(54) DISPLAY APPARATUS AND DISPLAY METHOD THEREOF

(71) Applicant: SAMSUNG ELECTRONICS CO., LTD., Suwon-si (KR)

(72) Inventor: Ho-woong Kang, Yongin-si (KR)

(73) Assignee: SAMSUNG ELECTRONICS CO., LTD., Suwon-si (KR)

(21) Appl. No.: 13/746,754

(22) Filed: Jan. 22, 2013

(30) Foreign Application Priority Data
Jan. 31, 2012 (KR) 10-2012-0010087

(51) Int. Cl. G09G 3/06

(52) U.S. Cl. CPC G09G 3/06
USPC 345/691

(57) ABSTRACT

A display apparatus is provided. The display apparatus includes a display unit that includes a plurality of pixels and is configured to display at least one image frame by illuminating the plurality of pixels on a pixel basis; a motion measuring unit that measures a motion per pixel of the at least one image frame by comparing a plurality of image frames to be displayed on the display unit; and a controller that adjusts a light emission intensity and a light emission time per pixel of the display unit according to a magnitude of the measured motion.

### CROSS-REFERENCE TO RELATED APPLICATIONS

This application claims priority from Korean Patent Application No. 10-2012-0010087 filed on Jan. 31, 2012 in the Korean Intellectual Property Office, the disclosure of which is incorporated herein in its entirety by reference.

### BACKGROUND

1. Field of the Invention

Methods and apparatuses consistent with exemplary embodiments relate to a display apparatus and a display method, and more particularly, to a display apparatus and a display method for driving the display apparatus on a pixel basis.

2. Description of the Related Art

Compared to cathode ray tube (CRT) display devices, liquid crystal display (LCD) devices are subject to severe motion blurring of moving video images. Since the CRT type display device has a blanking time between frames but the LCD type display device does not have such a blanking time, the moving image is blurred visually thereby creating a ghost effect.

Organic light-emitting diode (OLED) display devices produce light as much as each pixel represents the image on a frame basis throughout the whole pixel. The pixels also represent the gray scale according to currents flowing through a diode of each pixel. Hence, to represent one frame, the whole pixel consumes the current as much as the emission during the one frame.

Similar to the LCD type display devices, the OLED type display devices also suffer from motion blur. It is necessary to address the motion blur according to the characteristics of the OLED.

### SUMMARY

Exemplary embodiments may overcome the above-mentioned and/or other problems and disadvantages and an exemplary embodiment provides a display apparatus and a display method which reduce motion blur without changing the luminance.

According to an aspect of an exemplary embodiment, there is provided a display apparatus including a display unit which includes a plurality of pixels to display at least one image frame by illuminating the plurality of pixels on a pixel basis; a motion measuring unit to measure a motion per pixel of the at least one image frame by comparing a plurality of image frames to be displayed on the display unit; and a controller to adjust a light emission intensity and a light emission time per pixel of the display unit according to a magnitude of the measured motion.

The controller may divide the plurality of the pixels into a plurality of groups based on the measured motion magnitude, may adjust the light emission intensity of pixels of each group using a weight proportional to a motion magnitude of a corresponding group, and may control the display unit to illuminate the pixels of the corresponding group during the light emission time inversely proportional to the motion magnitude of the corresponding group.

The display unit may generate and sequentially display first, second, and third fields corresponding to each image frame. The controller may divide the plurality of the pixels into a maximum motion group, an intermediate motion group, and a minimum motion group based on the motion magnitude, may increase the light emission intensity of pixels corresponding to the maximum motion group in the first field by applying a maximum weight and may adjust the light emission intensity of the pixels corresponding to the maximum motion group to zero in the second and third fields. The controller may further increase the light emission intensity of pixels corresponding to the intermediate motion group in the first and second fields by applying an intermediate weight and may adjust the light emission intensity of the pixels corresponding to the intermediate motion group to zero in the third field, and maintain an original light emission intensity of the pixel corresponding to the minimum motion group in the first, second, and third fields.

The controller may divide the motion magnitude into a plurality of levels based on at least one threshold level, and may divide a display section of each image frame of the display unit into a plurality of fields as many corresponding to the plurality of levels. The controller may adjust the light emission intensity of the pixels of the motion magnitude corresponding to each level using the weight corresponding to the motion magnitude of each level, and may adjust the light emission time of the pixels of the motion magnitude corresponding to each level using the number of the fields corresponding to the motion magnitude of each level.

The controller may further divide the plurality of the pixels into a maximum motion group, an intermediate motion group, and a minimum motion group based on the motion magnitude, may divide a display section of each image frame of the display unit into first, second and third fields, may adjust the light emission intensity of the plurality of pixels corresponding to the maximum motion group by applying a maximum weight and may adjust the light emission time to illuminate pixels of the first field. The controller may then adjust the light emission intensity of the pixel corresponding to the intermediate motion group by applying an intermediate weight and adjusts the light emission time to illuminate pixels of the first and second fields, and may adjust the light emission time of the plurality of pixels corresponding to the minimum motion group to illuminate pixels of the first, second, and third fields without adjusting the light emission intensity.

A display method includes measuring motion per pixel of at least one image frame by comparing a plurality of image frames to be displayed in a display unit which comprises a plurality of pixels and displays an image frame by illuminating the pixels on a pixel basis and adjusting a light emission intensity and a light emission time per pixel of the display unit according to a magnitude of the measured motion.

The operation of adjusting the light emission intensity and the light emission time per pixel of the display unit may include dividing the plurality of the pixels into a plurality of groups based on the measured motion magnitude, adjusting the light emission intensity of the pixel of each group using a weight proportional to a motion magnitude of a corresponding group, and producing light during the light emission time inversely proportional to the motion magnitude of the corresponding group.

The method may further include generating and sequentially displaying first, second, and third fields for each image frame. The operation of adjusting of the light emission intensity and the light emission time per pixel of the display unit may include dividing the plurality of the pixels into a maximum motion group, an intermediate motion group, and a minimum motion group based on the motion magnitude, increasing the light emission intensity of pixels corresponding to the maximum motion group in the first field by applying a maximum weight and adjusting the light emission intensity of pixels corresponding to the maximum motion group to zero in the second and third fields. The operation of adjusting the light emission intensity and the light emission time per pixel of the display unit may further include increasing the light emission intensity of pixels corresponding to the intermediate motion group in the first and second fields by applying an intermediate weight and adjusting the light emission intensity of pixels corresponding to the intermediate motion group to zero in the third field, and maintaining an original light emission intensity of pixels corresponding to the minimum motion group in the first, second, and third fields.

The operation of adjusting the light emission intensity and the light emission time per pixel of the display unit may include dividing the motion magnitude into a plurality of levels based on at least one threshold level, dividing a display section of each image frame of the display unit into a plurality of fields corresponding to the plurality of levels, adjusting the light emission intensity of the pixels of the motion magnitude corresponding to each level using the weight corresponding to the motion magnitude of each level, and adjusting the light emission time of the pixels of the motion magnitude corresponding to each level using the fields corresponding to the motion magnitude of each level.

The operation of adjusting the light emission intensity and the light emission time per pixel of the display unit may further include dividing the plurality of the pixels into a maximum motion group, an intermediate motion group, and a minimum motion group based on the motion magnitude, dividing a display section of each image frame of the display unit into first, second and third fields, adjusting the light emission intensity of the plurality of pixels corresponding to the maximum motion group by applying a maximum weight and adjusting the light emission time to illuminate pixels of the first field, adjusting the light emission intensity of the plurality of pixels corresponding to the intermediate motion group by applying an intermediate weight and adjusting the light emission time to illuminate during the first and second fields, and adjust the light emission time of the plurality of pixels corresponding to the minimum motion group to illuminate pixels of the first, second, and third fields without adjusting the light emission intensity.

According to an aspect of another exemplary embodiment, there is provided a non-transitory computer-readable medium having a computer program embodied thereon, the computer program causing a computer to execute a display method, the method including measuring motion per pixel of at least one image frame by comparing a plurality of image frames to be displayed on a display unit which comprises a plurality of pixels and displays an image frame by illuminating the pixels on a pixel basis; and adjusting a light emission intensity and a light emission time per pixel of the display unit according to a magnitude of the measured motion.

The adjusting of the light emission intensity and the light emission time per pixel of the display unit may include dividing the plurality of the pixels into a plurality of groups based on the measured motion magnitude, adjusting the light emission intensity of the pixel of each group using a weight proportional to a motion magnitude of a corresponding group, and producing light during the light emission time inversely proportional to the motion magnitude of the corresponding group.

The display method may further include generating and sequentially displaying first, second, and third fields corresponding to each image frame, and the adjusting of the light emission intensity and the light emission time per pixel of the display unit includes dividing the plurality of the pixels into a maximum motion group, an intermediate motion group, and a minimum motion group based on the motion magnitude, increasing the light emission intensity of pixels corresponding to the maximum motion group in the first field by applying a maximum weight and adjusting the light emission intensity of pixels corresponding to the maximum motion group to zero in the second and third fields, increasing the light emission intensity of pixels corresponding to the intermediate motion group in the first and second fields by applying an intermediate weight and adjusting the light emission intensity of the pixels corresponding to the intermediate motion group to zero in the third field, and maintaining an original light emission intensity of pixels corresponding to the minimum motion group in the first, second, and third fields.

The adjusting of the light emission intensity and the light emission time per pixel of the display unit may include dividing the motion magnitude into a plurality of levels based on at least one threshold level, dividing a display section of each image frame of the display unit into a plurality of fields corresponding to the plurality of levels, adjusting the light emission intensity of the pixels of the motion magnitude corresponding to each level using the weight corresponding to the motion magnitude of each level, and adjusting the light emission time of the pixels of the motion magnitude corresponding to each level using the fields corresponding to the motion magnitude of each level.

The adjusting the light emission intensity and the light emission time per pixel of the display unit may further include dividing the plurality of the pixels into a maximum motion group, an intermediate motion group, and a minimum motion group based on the motion magnitude, dividing a display section of each image frame of the display unit into first, second and third fields, adjusting the light emission intensity of the plurality of pixels corresponding to the maximum motion group by applying a maximum weight and adjusting the light emission time to illuminate pixels of the first field, adjusting the light emission intensity of the plurality of pixels corresponding to the intermediate motion group by applying an intermediate weight and adjusts the light emission time to illuminate pixels of the first and second fields, and adjusting the light emission time of the plurality of pixels corresponding to the minimum motion group to illuminate pixels of the first, second, and third fields without adjusting the light emission intensity.

### BRIEF DESCRIPTION OF THE DRAWING FIGURES

These and/or other aspects and advantages of the present general inventive concept will be more apparent by describing certain exemplary embodiments, with reference to the accompanying drawings, in which:

FIG. 1A is a diagram illustrating a general principle according to an exemplary embodiment;

FIG. 1B is a diagram illustrating a method to reduce motion blur according to an exemplary embodiment;

FIG. 2A is a simplified diagram illustrating a circuit of the display apparatus according to an exemplary embodiment;

FIG. 2B is a diagram illustrating a circuit of a pixel according to an exemplary embodiment;

FIG. 3 is a block diagram of the display apparatus according to an exemplary embodiment;

FIG. 4A is a diagram illustrating a motion measurement result of an N-th frame image according to an exemplary embodiment;

FIG. 4B is a diagram illustrating a frame driving method according to an exemplary embodiment;

FIG. 4C is a diagram illustrating a frame driving method according to another exemplary embodiment; and

FIG. 5 is a flowchart of the display method according to an exemplary embodiment.

### DETAILED DESCRIPTION OF THE EXEMPLARY EMBODIMENTS

Exemplary embodiments of the present general inventive concept will now be described in more detail with reference to the accompanying drawings, in which exemplary embodiments are shown and in which like reference numerals refer to the same elements when they are depicted in different drawings. The exemplary embodiments are provided to assist in a comprehensive understanding of exemplary embodiments of the present general inventive concept.

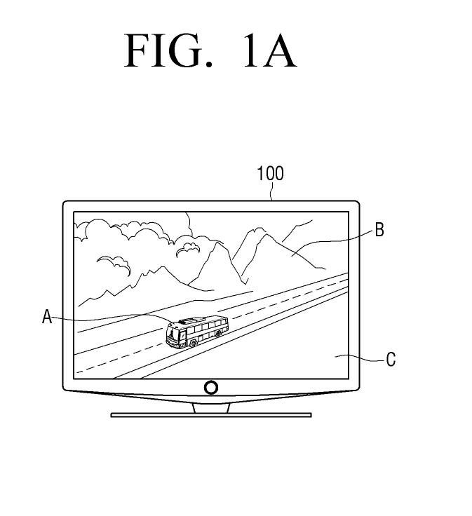

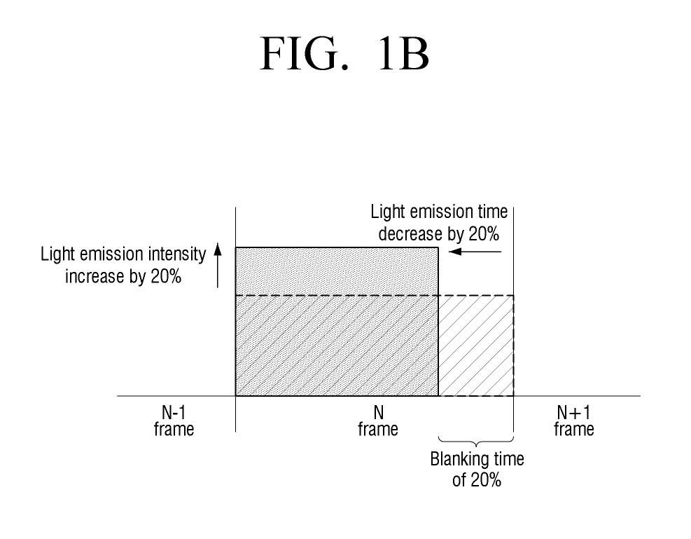

FIGS. 1A and 1B are diagrams illustrating a general principle of an exemplary embodiment.

As shown in FIG. 1A, in an image displayed in a display apparatus 100, a region A represents a part of the image with a greatest motion, a region B represents a part of the image with an intermediate motion, and a region C represents a part of the image with a little motion.

Pixels corresponding to the region A of the great motion continuously change their light amount on a frame basis, whereas pixels corresponding to the region C of little motion keep their light amount during a great number of frames.

Even an OLED display apparatus with a fast response time is subject to visual motion blurring. This results from vision reaction characteristics of the human eye because afterimages are recognized by retinas which cause the motion blur. In particular, the region A of the great motion may have severe blurring.

An exemplary embodiment of the present general inventive concept provides a method to reduce the blurring using the principle depicted in FIG. 1B.

As shown in FIG. 1B, when a particular pixel of an N frame image increases the emission intensity of the pixel by 20% and decreases the emission time by 20%, the brightness of the whole region can be maintained and a blanking time of 20% can be attained in the vertical cycle of the frame. Since the OLED itself emits the light on a pixel basis, the motion can be detected by analyzing the image pixels. When much motion is detected, the regions of the different motion levels can be differently driven by proportionally applying the driving time and the current of each pixel and thus only the region for which such an operation is necessary can be operated in a blanking interval.

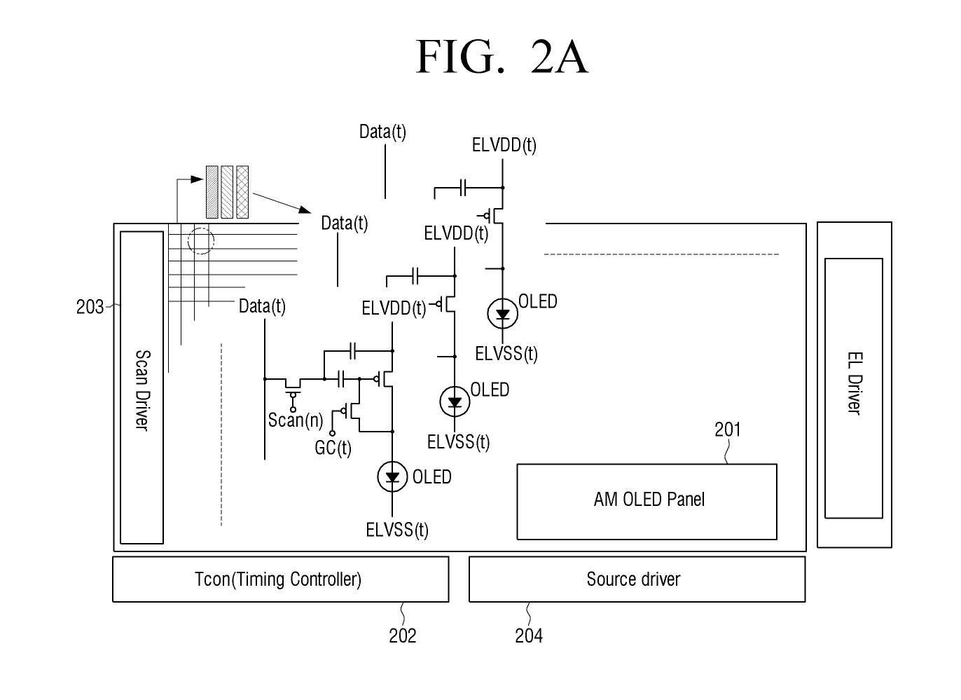

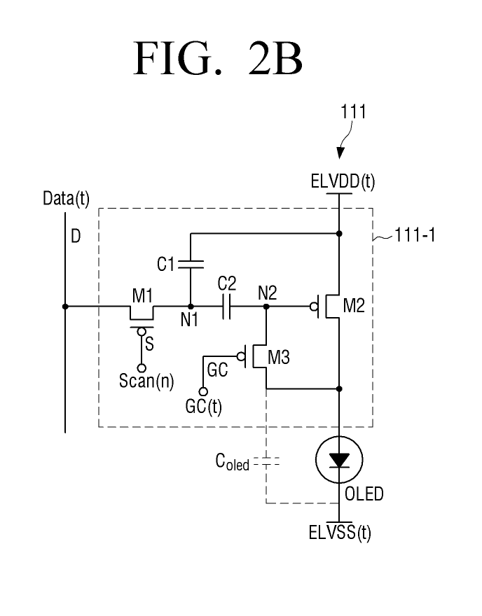

FIGS. 2A and 2B are diagrams of a display apparatus according to an exemplary embodiment.

FIG. 2A is a simplified diagram illustrating a circuit of the display apparatus according to an exemplary embodiment.

The display apparatus of FIG. 2A can be implemented by using an Active Matrix Organic Light-Emitting Diode (AM-OLED). Generally, the OLED itself produces the light using electroluminescence when the current flows through a fluorescent or phosphorescent layer. While a Passive Matrix (PM-OLED) emits light per line of light emitting elements, the AM-OLED individually drives each of the light emitting elements.

As shown in FIG. 2A, an AM-OLED panel 201 may include RGB pixels including a thin film transistor (TFT) element and an organic electro-luminescence (EL) element. The TFT is driven by a timing controller 202, a scan driver 203, and a source driver 204, and writes image information to the display unit.

The active matrix is driven by the TFT of the pixel and Data(t), based on which the active matrix is driven, is provided through an external switch (not shown). When the light is emitted, the external switch (not shown) connects to a power source to supply the necessary energy for the light emission.

FIG. 2B is a diagram illustrating a circuit of a pixel according to an exemplary embodiment.

Referring to FIG. 2B, the pixel 111 according to an exemplary embodiment includes an OLED and a pixel circuit 111-1 for supplying a current to the OLED.

An anode electrode of the OLED is connected to the pixel circuit 111-1 and a cathode electrode of the OLED is connected to a second power source ELVSS(t). The OLED produces light with a certain luminance in response to a current supplied by the pixel circuit 111-1.

The pixel circuit 111-1 of each pixel 111 may include three transistors M1, M2 and M3 and two capacitors C1 and C2, as shown in FIG. 2B.

A gate electrode of the first transistor M1 is connected to a scan line S, and a first electrode is connected to a data line D. A second electrode of the first transistor M1 is connected to a first node N1.

A scan signal Scan(n) is input to the gate electrode of the first transistor M1, and a data signal Data(t) is input to the first electrode of the first transistor M1.

A gate electrode of the second transistor M2 is connected to a second node N2, a first electrode of the second transistor M2 is connected to a first power source ELVDD(t), and a second electrode of the second transistor M2 is connected to the anode electrode of the OLED. Herein, the second transistor M2 serves as a driving transistor.

The first capacitor C1 is provided between the first node N1 and the first node of the second transistor M2. The first power source ELVDD(t) and the second capacitor C2 are provided between the first node N1 and the second node N2.

A control line GC is connected to a gate electrode of the third transistor M3, the first electrode of the third transistor M3 is connected to the gate electrode of the second transistor M2, and the second electrode of the third transistor M3 is connected to the anode electrode of the OLED and to the second electrode of the second transistor M2. A control signal GC(t) is input to the gate electrode of the third transistor M3. When the third transistor is turned on, the second transistor M2 is diode-connected. The cathode electrode of the OLED is connected to a second power source ELVSS(t).

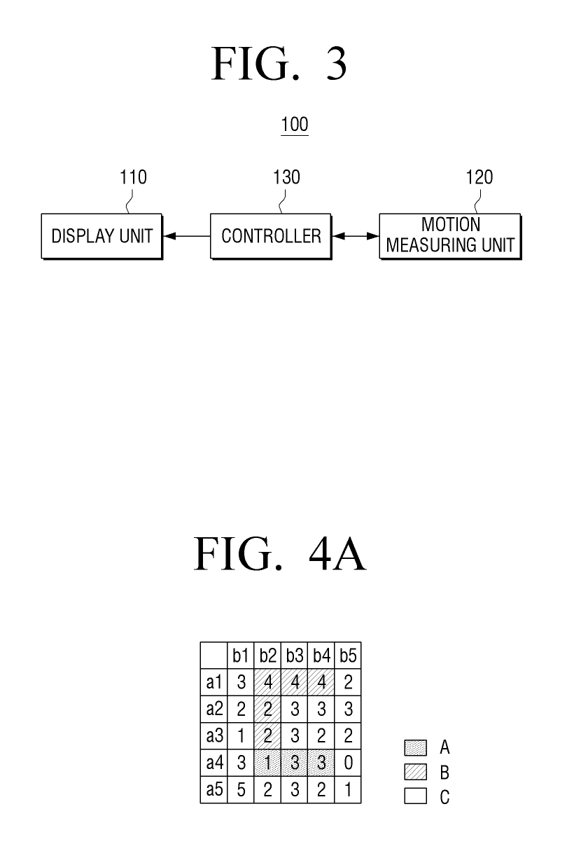

FIG. 3 is a block diagram of the display apparatus according to an exemplary embodiment.

Referring to FIG. 3, the display apparatus 100 includes a display unit 110, a motion measuring unit 120, and a controller 130.

The display unit 110 includes a plurality of pixels, and displays an image frame by illuminating the pixels on a pixel basis. The display unit 110 may be implemented using an OLED panel, which has been explained above.

The motion measuring unit 120 measures a motion per pixel in each frame by comparing a plurality of image frames to be displayed in the display unit 110. The motion measuring unit 120 may be implemented by the controller 130 or by another controller or processor.

The controller 130 controls a light emission intensity and a light emission time per pixel of the display unit 110 according to the motion magnitude measured by the motion measuring unit 120.

More specifically, the controller 130 may divide the pixels to form a plurality of groups based on a motion magnitude measured by the motion measuring unit 120. The controller 130 may further adjust the light emission intensity of the pixels of each group using a weight proportional to the motion magnitude of the corresponding group, and may control the display unit 110 to produce the light during the light emission time inversely proportional to the motion magnitude of the corresponding group.

The controller 130 may divide at least one image frame into a plurality of fields according to the motion magnitude measured by the motion measuring unit 120, and may adjust the light emission intensity of the pixels by differently weighting the plurality of the fields.

The controller 130 may also divide the motion magnitude into a plurality of levels based on at least one threshold level, and may divide the display section of each image frame displayed on the display unit 110 to a plurality of fields corresponding to a number of the levels.

More specifically, the controller 130 may adjust the light emission intensity of the pixels of the motion magnitude corresponding to each magnitude level using the weight corresponding to the motion magnitude of each level, and may adjust the light emission time of the pixels of the motion magnitude corresponding to each magnitude level using the number of the fields corresponding to the motion magnitude of each level.

Pixel data per field may be generated and driven individually, or pixel data and duration data of one field may be generated and driven.

In an exemplary embodiment, the controller 130 divides each image frame into three fields according to the motion measured by the motion measuring unit 120. However, the number of the fields is not limited to three, and a person of ordinary skill in the related art will readily understand that the number of the fields, into which each image frame may be divided based on the measured motion, may vary.

### Generation and Driving of Pixel Data Per Field

The display unit 130 may generate and sequentially display first, second, and third fields for each image frame, and the controller 130 may divide the pixels into a maximum motion group, an intermediate motion group, and a minimum motion group based on the measured motion magnitude.

The controller 130 may increase the light emission intensity of the pixels corresponding to the maximum motion group by applying a maximum weight within the first field, and may control it to be zero in the second and third fields.

The controller 130 may increase the light emission intensity of the pixels corresponding to the intermediate motion group by applying an intermediate weight within the first and second fields, and may control it to be zero in the third field.

The controller 130 may maintain the original light emission intensity of the pixels corresponding to the minimum motion group during the first, second and third fields.

### Generation and Driving of Pixel Data and Light Emission Time Data of One Field

The controller 130 may divide the plurality of the pixels into a maximum motion group, an intermediate motion group, and a minimum motion group based on the measured motion magnitude, and may divide the display section of each image frame of the display unit 110 into first, second and third fields.

The controller 130 may adjust the light emission intensity by applying a maximum weight to the pixels corresponding to the maximum motion group, and may adjust the light emission time to illuminate the pixels of the first field.

The controller 130 may adjust the light emission intensity by applying an intermediate weight to the pixels corresponding to the intermediate motion group, and may adjust the light emission time to illuminate the pixels of the first and second fields.

The controller 130 may not adjust the light emission intensity of the pixels corresponding to the minimum motion group, and may adjust the light emission time to illuminate the pixels of the first, second, and third fields.

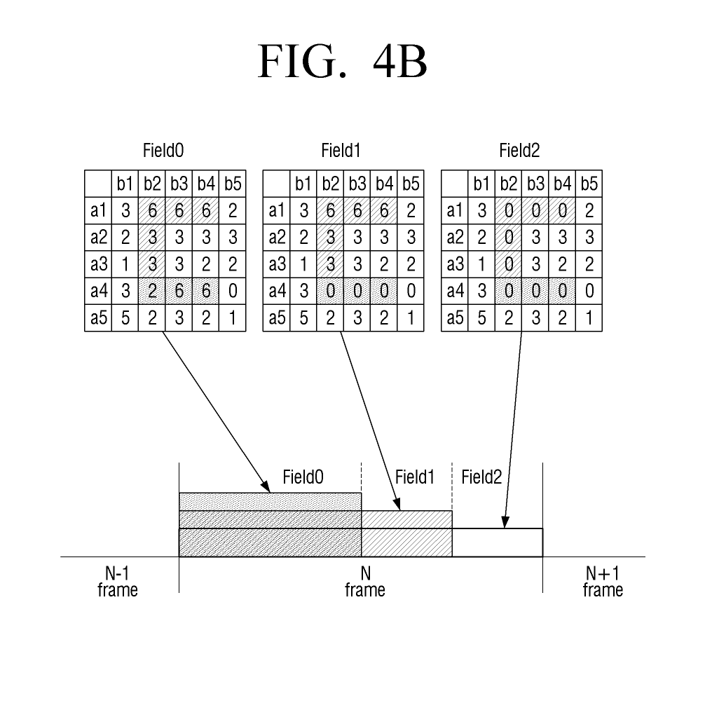

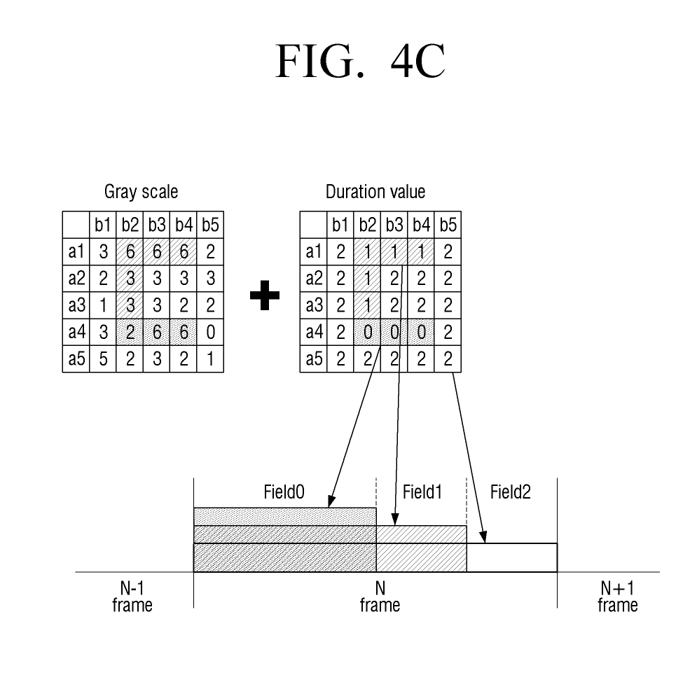

FIGS. 4A, 4B and 4C are diagrams of a display method according to an exemplary embodiment. For a better understanding, one frame includes 5*5 pixels in this exemplary embodiment. However, the exemplary embodiment is not limited to 5*5 pixels.

FIG. 4A is a diagram illustrating a motion measurement result of an N-th frame image according to an exemplary embodiment.

According to the motion measurement result of the N-th image frame, as shown in FIG. 4A, a region A represents a maximum motion group of a greatest motion, a region B represents an intermediate motion group of an intermediate motion, a region C represents a minimum motion group of a minimum motion, and the number written in a pixel indicates the luminance value of the pixel.

FIG. 4B is a diagram illustrating a frame driving method according to an exemplary embodiment.

When the pixels of the N-th frame are divided into three groups based on the motion magnitude as shown in FIG. 4A, the N-th frame may be driven sequentially by dividing the frame into three fields including a first field 0, a second field 1, and a third field 2 corresponding to the groups, as shown in FIG. 4B.

The light emission intensity of the pixels corresponding to the maximum motion group A is increased by applying the maximum weight of 2, the light emission intensity of the pixels corresponding to the intermediate motion group B is increased by applying the intermediate weight of 1.5, and the light emission intensity of the pixels corresponding to the minimum motion group C may maintain the original light emission intensity.

Hence, the light emission intensity of the maximum motion group A is increased from the original light emission intensity (1, 3, 3) to the light emission intensity (2, 6, 6) by applying the maximum weight of 2, the light emission intensity of the intermediate motion group B is increased from the original light emission intensity (2, 2, 4, 4, 4) to the light emission intensity (3, 3, 6, 6, 6) by applying the intermediate weight of 1.5, and the light emission intensity of the minimum motion group C maintains the original light emission intensity (3, 2, 1, 3, 5, 2, 3, 2, 1).

The maximum motion group A is driven with the light emission intensity (2, 6, 6) which is increased from the original light emission intensity (1, 3, 3) by applying the maximum weight of 2 in the first field, and which does not produce light in the second and third fields.

The intermediate motion group B is driven with the light emission intensity (3, 3, 6, 6, 6) which is increased from the original light emission intensity (2, 2, 4, 4, 4) by applying the intermediate weight of 1.5 in the first field 0 and the second field 1, and which does not produce light in the third field.

The minimum motion group C maintains the original light emission intensity in the first field 0, the second field 1, and the third field 2.

Since the maximum motion group A and the intermediate motion group B include a blanking interval corresponding to the motion magnitude, blurring can be minimized. For example, the maximum motion group A includes the second field 1 and the third field 2 as a blanking intervals, and the intermediate motion group B includes the third field 2 as a blanking interval.

FIG. 4C is a diagram illustrating a frame driving method according to another exemplary embodiment.

Referring to FIG. 4C, the light emission intensity of the pixels corresponding to the maximum motion group A may be adjusted by applying the maximum weight of 2 and by adjusting the light emission time to illuminate pixels of the first field 0. Accordingly, the light emission intensity is set to (2, 6, 6) and the duration value is set to zero to illuminate the pixels of the first field 0.

The light emission intensity of the pixels corresponding to the intermediate motion group B may be adjusted by applying the intermediate weight of 1.5 and by adjusting the light emission time to illuminate pixels of the first field 0 and the second field 1. Accordingly, the light emission intensity is set to (3, 3, 6, 6, 6) and the duration value is set to 1 to illuminate pixels of the first field 0 and the second field 1.

The light emission time of the pixel corresponding to the minimum motion group C may be adjusted to illuminate pixels of the first field 0, the second field 1, and the third field 2 without adjusting the light emission intensity. Accordingly, the light emission intensity is set to the original intensity and the duration value is set to 2 to illuminate pixels of the first field 0, the second field 1, and the third field 2.

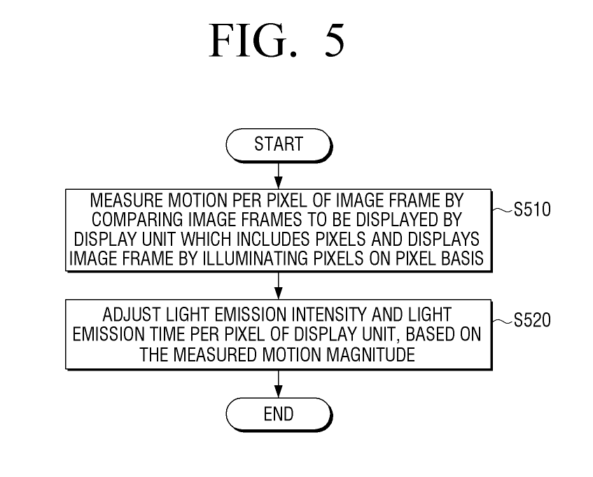

FIG. 5 is a flowchart of the display method according to an exemplary embodiment.

The display method of FIG. 5 measures the motion per pixel in each image frame by comparing the plurality of the image frames to be displayed in the display unit (S510). The display unit includes a plurality of the pixels and displays an image frame by illuminating the pixels on a pixel basis.

Next, the display method adjusts the light emission intensity and the light emission time per pixel of the display unit, based on the measured motion magnitude (S520).

In operation S520 the light emission intensity and the light emission time per pixel of the display unit may be adjusted and the plurality of the pixels may be divided into a plurality of groups based on the motion magnitude measured in operation S510. The light emission intensity of the pixels of each group may be adjusted using the weight proportional to the motion magnitude of the corresponding group, and light may be produced inversely proportional to the motion magnitude of the corresponding group during the light emission time.

More specifically, the display unit may generate and sequentially display the first, second and third field for each image frame. At this time, in operation S520 the light emission intensity and the light emission time per pixel of the display unit may be adjusted and the plurality of the pixels may be divided into the maximum motion group, the intermediate motion group, and the minimum motion group based on the motion magnitude.

The light emission intensity of the pixels corresponding to the maximum motion group may be increased in the first field by applying the maximum weight and the light emission intensity may be adjusted to zero in the second and third fields. The light emission intensity of the pixels corresponding to the intermediate motion group may be increased in the first and second fields by applying the intermediate weight and may be adjusted to zero in the third field. The original light emission intensity of the pixels corresponding to the minimum motion group may be maintained in the first, second, and third fields.

In operation S520 the light emission intensity and the light emission time per pixel of the display unit may be adjusted and the motion magnitude may be divided into the several levels based on at least one threshold level and the display section of each image frame of the display unit may be divided into the plurality of the fields corresponding to the levels.

The light emission intensity of the pixels having the motion magnitude corresponding to each level of the motion magnitude may be adjusted using the weight corresponding to the motion magnitude of each level, and the light emission time of the pixels having the motion magnitude corresponding to each level using the number of the fields corresponding to the motion magnitude of each level.

In operation S520 the light emission intensity and the light emission time per pixel of the display unit may be adjusted and the plurality of the pixels may be divided into the maximum motion group, the intermediate motion group, and the minimum motion group based on the motion magnitude and the display section of each image frame of the display unit may be divided into the first, second, and third fields.

The light emission intensity of the pixels corresponding to the maximum motion group may be adjust by applying the maximum weight and by adjusting the light emission time to illuminate pixels of the first field. The light emission intensity of the pixels corresponding to the intermediate motion group may be adjusted by applying the intermediate weight and by adjusting the light emission time to illuminate pixels of the first and second fields. The light emission time of the pixels corresponding to the minimum motion group may be adjusted to illuminate pixels of the first, second, and third fields without adjusting the light emission intensity.

The number into which the motion groups are divided based on the motion magnitude is not limited to three.

By performing the operations as shown in FIG. 5, the sharpness of the video images can be enhanced.

A program for executing the method according to various exemplary embodiments of the present general inventive concept can be stored on various computer-readable recoding media.

Specifically, a code for executing the methods can be stored to various non-transitory computer-readable recording media including Random Access Memory (RAM), flash memory, Read Only Memory (ROM), Erasable Programmable ROM (EPROM), Electronically Erasable and Programmable ROM (EEPROM), register, hard disc, removable disc, memory card, USB memory, and CD-ROM.

The foregoing exemplary embodiments and advantages are merely exemplary and are not to be construed as limiting the present inventive concept. The description of the exemplary embodiments is intended to be illustrative, and not to limit the scope of the claims, an many alternatives, modifications, and variations will be apparent to those skilled in the art.

What is claimed is:

1. A display apparatus comprising:
a display unit that comprises a plurality of pixels and is configured to display at least one image frame by illuminating the plurality of pixels on a pixel basis;
a motion measuring unit that measures a motion per pixel of the at least one image frame by comparing a plurality of image frames to be displayed on the display unit; and
a controller that adjusts a light emission intensity and a light emission time per pixel of the display unit according to a magnitude of the measured motion.

2. The display apparatus of claim 1, wherein the controller divides the plurality of the pixels into a plurality of groups based on the measured motion magnitude, adjusts the light emission intensity of pixels of each group using a weight proportional to a motion magnitude of a corresponding group, and controls the display unit to illuminate the pixels of the corresponding group during the light emission time inversely proportional to the motion magnitude of the corresponding group.

3. The display apparatus of claim 2, wherein the display unit generates and sequentially displays first, second, and third fields corresponding to each image frame,
wherein the controller divides the plurality of the pixels into a maximum motion group, an intermediate motion group, and a minimum motion group based on the motion magnitude,
wherein the controller increases the light emission intensity of pixels corresponding to the maximum motion group in the first field by applying a maximum weight and adjusts the light emission intensity of the pixels corresponding to the maximum motion group to zero in the second and third fields,
wherein the controller increases the light emission intensity of pixels corresponding to the intermediate motion group in the first and second fields by applying an intermediate weight and adjusts the light emission intensity of the pixels corresponding to the intermediate motion group to zero in the third field, and
wherein the controller maintains an original light emission intensity of pixels corresponding to the minimum motion group in the first, second, and third fields.

4. The display apparatus of claim 2, wherein the controller divides the motion magnitude into a plurality of levels based on at least one threshold level, and divides a display section of each image frame of the display unit into a plurality of fields corresponding to the plurality of levels,
wherein the controller adjusts the light emission intensity of the pixels of the motion magnitude corresponding to each level using the weight corresponding to the motion magnitude of each level, and
wherein the controller adjusts the light emission time of the pixels of the motion magnitude corresponding to each level using the number of the fields corresponding to the motion magnitude of each level.

5. The display apparatus of claim 2, wherein the controller
divides the plurality of the pixels into a maximum motion group, an intermediate motion group, and a minimum motion group based on the motion magnitude,
divides a display section of each image frame of the display unit into first, second and third fields,
adjusts the light emission intensity of the plurality of pixels corresponding to the maximum motion group by applying a maximum weight and adjusts the light emission time to illuminate pixels of the first field,
adjusts the light emission intensity of the plurality of pixels corresponding to the intermediate motion group by applying an intermediate weight and adjusts the light emission time to illuminate pixels of the first and second fields, and
adjusts the light emission time of the plurality of pixels corresponding to the minimum motion group to illuminate pixels of the first, second, and third fields without adjusting the light emission intensity.

6. A display method comprising:
measuring motion per pixel of at least one image frame by comparing a plurality of image frames to be displayed on a display unit which comprises a plurality of pixels and displays an image frame by illuminating the pixels on a pixel basis; and
adjusting a light emission intensity and a light emission time per pixel of the display unit according to a magnitude of the measured motion.

7. The display method of claim 6, wherein the adjusting of the light emission intensity and the light emission time per pixel of the display unit comprises
dividing the plurality of the pixels into a plurality of groups based on the measured motion magnitude,
adjusting the light emission intensity of the pixel of each group using a weight proportional to a motion magnitude of a corresponding group, and
producing light during the light emission time inversely proportional to the motion magnitude of the corresponding group.

8. The display method of claim 7, further comprising generating and sequentially displaying first, second, and third fields corresponding to each image frame,
wherein the adjusting of the light emission intensity and the light emission time per pixel of the display unit comprises:
dividing the plurality of the pixels into a maximum motion group, an intermediate motion group, and a minimum motion group based on the motion magnitude,
increasing the light emission intensity of pixels corresponding to the maximum motion group in the first field by applying a maximum weight and adjusting the light emission intensity of pixels corresponding to the maximum motion group to zero in the second and third fields,
increasing the light emission intensity of pixels corresponding to the intermediate motion group in the first and second fields by applying an intermediate weight and adjusting the light emission intensity of the pixels corresponding to the intermediate motion group to zero in the third field, and
maintaining an original light emission intensity of pixels corresponding to the minimum motion group in the first, second, and third fields.

9. The display method of claim 7, wherein the adjusting the light emission intensity and the light emission time per pixel of the display unit comprises
dividing the motion magnitude into a plurality of levels based on at least one threshold level,
dividing a display section of each image frame of the display unit into a plurality of fields corresponding to the plurality of levels,
adjusting the light emission intensity of the pixels of the motion magnitude corresponding to each level using the weight corresponding to the motion magnitude of each level, and
adjusting the light emission time of the pixels of the motion magnitude corresponding to each level using the fields corresponding to the motion magnitude of each level.

10. The display method of claim 7, wherein the adjusting the light emission intensity and the light emission time per pixel of the display unit comprises:
dividing the plurality of the pixels into a maximum motion group, an intermediate motion group, and a minimum motion group based on the motion magnitude,
dividing a display section of each image frame of the display unit into first, second and third fields,
adjusting the light emission intensity of the plurality of pixels corresponding to the maximum motion group by applying a maximum weight and adjusts the light emission time to illuminate pixels of the first field,
adjusting the light emission intensity of the plurality of pixels corresponding to the intermediate motion group by applying an intermediate weight and adjusting the light emission time to illuminate pixels of the first and second fields, and
adjusting the light emission time of the plurality of pixels corresponding to the minimum motion group to illuminate pixels of the first, second, and third fields without adjusting the light emission intensity.

11. A non-transitory computer-readable medium having a computer program embodied thereon, the computer program causing a computer to execute a display method comprising:
measuring motion per pixel of at least one image frame by comparing a plurality of image frames to be displayed on a display unit which comprises a plurality of pixels and displays an image frame by illuminating the pixels on a pixel basis; and
adjusting a light emission intensity and a light emission time per pixel of the display unit according to a magnitude of the measured motion.

12. The non-transitory computer-readable medium of claim 11, wherein the adjusting the light emission intensity and the light emission time per pixel of the display unit comprises:
dividing the plurality of the pixels into a plurality of groups based on the measured motion magnitude,
adjusting the light emission intensity of the pixel of each group using a weight proportional to a motion magnitude of a corresponding group, and
producing light during the light emission time inversely proportional to the motion magnitude of the corresponding group.

13. The non-transitory computer-readable medium of claim 12, wherein the display method further comprises generating and sequentially displaying first, second, and third fields corresponding to each image frame,
wherein the adjusting of the light emission intensity and the light emission time per pixel of the display unit comprises:
dividing the plurality of the pixels into a maximum motion group, an intermediate motion group, and a minimum motion group based on the motion magnitude,
increasing the light emission intensity of pixels corresponding to the maximum motion group in the first field by applying a maximum weight and adjusting the light emission intensity of pixels corresponding to the maximum motion group to zero in the second and third fields,
increasing the light emission intensity of pixels corresponding to the intermediate motion group in the first and second fields by applying an intermediate weight and adjusting the light emission intensity of the pixels corresponding to the intermediate motion group to zero in the third field, and
maintaining an original light emission intensity of pixels corresponding to the minimum motion group in the first, second, and third fields.

14. The non-transitory computer-readable medium of claim 12, wherein the adjusting the light emission intensity and the light emission time per pixel of the display unit comprises:
dividing the motion magnitude into a plurality of levels based on at least one threshold level,
dividing a display section of each image frame of the display unit into a plurality of fields corresponding to the plurality of levels,
adjusting the light emission intensity of the pixels of the motion magnitude corresponding to each level using the weight corresponding to the motion magnitude of each level, and
adjusting the light emission time of the pixels of the motion magnitude corresponding to each level using the fields corresponding to the motion magnitude of each level.

15. The non-transitory computer-readable medium of claim 12, wherein the adjusting the light emission intensity and the light emission time per pixel of the display unit comprises:
dividing the plurality of the pixels into a maximum motion group, an intermediate motion group, and a minimum motion group based on the motion magnitude,
dividing a display section of each image frame of the display unit into first, second and third fields,
adjusting the light emission intensity of the plurality of pixels corresponding to the maximum motion group by applying a maximum weight and adjusting the light emission time to illuminate pixels of the first field,
adjusting the light emission intensity of the plurality of pixels corresponding to the intermediate motion group by applying an intermediate weight and adjusts the light emission time to illuminate pixels of the first and second fields, and
adjusting the light emission time of the plurality of pixels corresponding to the minimum motion group to illuminate pixels of the first, second, and third fields without adjusting the light emission intensity.
